(19) United States
(12) Patent Application Publication
(10) Pub. No.: US 2007/0180090 A1
(43) Pub. Date: Aug. 2, 2007

(54) DNS TRAFFIC SWITCH

(75) Inventors: Robert M. Fleischman, Concord, NH (US); William Thomas Waters, Clifton Park, NY (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Simplicita Software, Inc., Denver, CO (US)

(21) Appl. No.: 11/563,290

(22) Filed: Nov. 27, 2006

Related U.S. Application Data
(60) Provisional application No. 60/766,629, filed on Feb. 1, 2006.

(51) Int. Cl. G06F 15/173

(52) U.S. Cl. 709/223; 709/238

(57) ABSTRACT

A device, method and system for regulating networks using Domain Name System (DNS) is disclosed herein. The exemplary method may receive a DNS transaction between a DNS client and a DNS server. DNS information associated with the DNS transaction is identified. An appropriate action for the transaction may be applied to the DNS information based on network security rules.

### CROSS-REFERENCE TO RELATED APPLICATIONS

This application claims priority to U.S. Patent Application No. 60/766,529 filed Jan. 25, 2006 entitled A Switching System for DNS, which is incorporated fully herein by reference.

### TECHNICAL FIELD

The present invention relates to Domain Name System (DNS) and more particularly, relates to monitoring and switching DNS.

### BACKGROUND INFORMATION

### Domain Name System (DNS)

Referring to FIG. 1, Domain Name System (DNS) 100 provides a structure for a network of devices to identify and locate other devices on a network. A client 102 on the network that wishes to communicate with another client 104 on the network transmits a request to a DNS server 106. An Internet Service Provider (ISP) 108 may be used by the client 102 and/or the other client/server 104 to provide access to the Internet and communicate with one another. The requests and responses may be sent as packets using User Datagram Protocol (UDP), which allows the networked computers to communicate with one another in a standardized fashion. The request, sent by the client to the DNS server 106, has a unique IP address associated with the other client 104 and is transmitted using, for example, Transport Control Protocol/Internet Protocol (TCP/IP). The DNS server 106 may then identify a resource record associated with the unique address and provides zones and address information of the other client 104 in a response transmitted back to the requesting client 102. The client 102 may now identify the other client 104 and communicate with the other client 104 using the address information.

The domain name structure has a hierarchy of domain names. Each domain name is associated with a node in a hierarchy pyramid. The node has an associated resource record, which holds the information associated with the domain name. The structure is sub-divided into zones. Each zone comprises a collection of connected nodes authoritatively served by an authoritative DNS server. A name, called a domain name, is used to organize clients into groups. The domain name is hierarchically appended to each organization type, each organization name, or each post in an organization such as a nation, a company, or a scientific or academic organization, and the host name is assured of its uniqueness in the TCP/IP network by being combined with the domain name. For example, the server hosting the World Wide Web site of Simplicita Software Inc., which is connected to the Internet, can be represented in a description form, WWW.SIMPLICITA.COM.

A DNS server 102 may comprise a hierarchical set of DNS servers. Each domain or sub-domain has one or more authoritative DNS servers that publish information about that domain and the name servers of any domains “beneath” that server. The hierarchy of authoritative DNS servers may match the hierarchy of domains. When a request is received by the DNS server 102, a sub-level domain 112 may identify the information associated with the domain or direct the query to a root servers 110 or an additional sub-level domain 114. Once the resource record is identified, the information is transmitted back to the client 102 to be used to locate the other client 104.

The DNS system 100 is for illustrative purposes and does not serve a complete description of DNS. Many components of the system and its complexity are not depicted in the DNS system 100 for illustrative purposes. For example, DNS caches may be provided to reduce the traffic on DNS servers. A result of a queue may be stored in a DNS cache for a predefined duration. Subsequent queues may identify the result using the DNS cache. ISP 108 client browsers and other access points may provide variations of DNS server/cache functions.

### Zombie and Bots

A zombie computer is a computer attached to the Internet that has been compromised by a security hole. The victim computer may be programmed or directly controlled by a remote computer or network of another computer to perform malicious tasks. The tasks include but are not limited to spam, acting as a bot, access pay per click advertising, phishing, and distributed denial of service attacks. The administrator of the victim computer may not be aware of the zombie and its actions. The zombie may have been implemented via, for example, a virus, a worm, or a trojan horse. Not only are many administrators not aware of the infected computers but the administrator may not know how to identify and cure the zombie program. Zombies and Bots perform many malicious tasks and produce illegitimate, wasteful network traffic. Accordingly, a need exists for a device, method, and system for identifying and/or removing infected computers from a network.

### SUMMARY

The present invention is a novel device, system, and method for regulating networks using Domain Name System (DNS). The exemplary method may receive a DNS transaction between a DNS client and a DNS server. DNS information associated with the DNS transaction is identified. An appropriate action for the transaction may be applied to the DNS information based on network security rules.

In another exemplary embodiment, the appropriate action may drop a packet from the network associated with the transaction. In another exemplary embodiment, the appropriate action may modify the DNS information and may transmit the transaction with modified DNS information. In another exemplary embodiment, the appropriate action may generate a new request for the DNS Server. A response from the DNS Server is received and the DNS information may be modified based on the response. The response may be transmitted with modified DNS information to the DNS client. In yet another aspect, the DNS switch may be within a DNS server, within a computer of a DNS client and/or between a DNS server and a DNS client.

Embodiments of the invention may have one or more of the following advantages. Aspects of the invention may allow the detection, isolation and/or curing of infected computers without the need to curtail services. Aspects of the invention may reduce the need for direct customer support. Aspects of the invention may reduce damage to infected computers. Aspects of the invention may be used to prohibit access of undesirable content. Aspects of the invention may be used to protect and segment DNS infrastructure.

The present invention is not intended to be limited to a system or method that must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram of an exemplary DNS system.

FIG. 2 is a system diagram of an exemplary DNS switching system according to an exemplary embodiment of the present invention.

FIG. 3A is a system diagram of an exemplary DNS system according to an exemplary switch embodiment of the present invention.

FIG. 3B is a system diagram of an exemplary DNS system according to an exemplary DNS server switch embodiment of the present invention.

FIG. 3C is a system diagram of an exemplary DNS system according to an exemplary DNS client switch embodiment of the present invention.

FIG. 4 is a flow chart illustrating an exemplary embodiment used for the switching method according to the present invention.

FIG. 5A is a flow chart illustrating an exemplary embodiment used for the switching method causing the transaction to be dropped according to the present invention.

FIG. 5B is a flow chart illustrating an exemplary embodiment used for the switching method causing the transaction to be modified according to the present invention.

FIG. 5C is a flow chart illustrating an exemplary embodiment used for the switching method causing the transaction to be identified and modified according to the present invention.

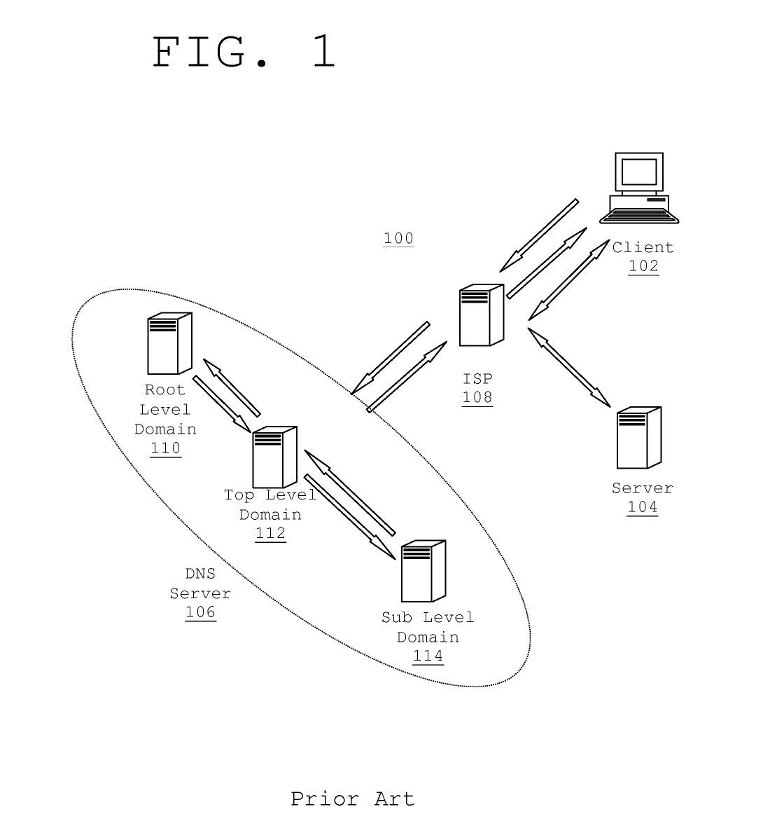

### DETAILED DESCRIPTION

Embodiments of the present invention may be used to monitor and control network traffic by utilizing the Domain Name System (DNS). The system identifies DNS transactions and uses this information to monitor and control network traffic based on identified DNS information. The system may modify DNS transactions to regulate network traffic based on identified DNS information.

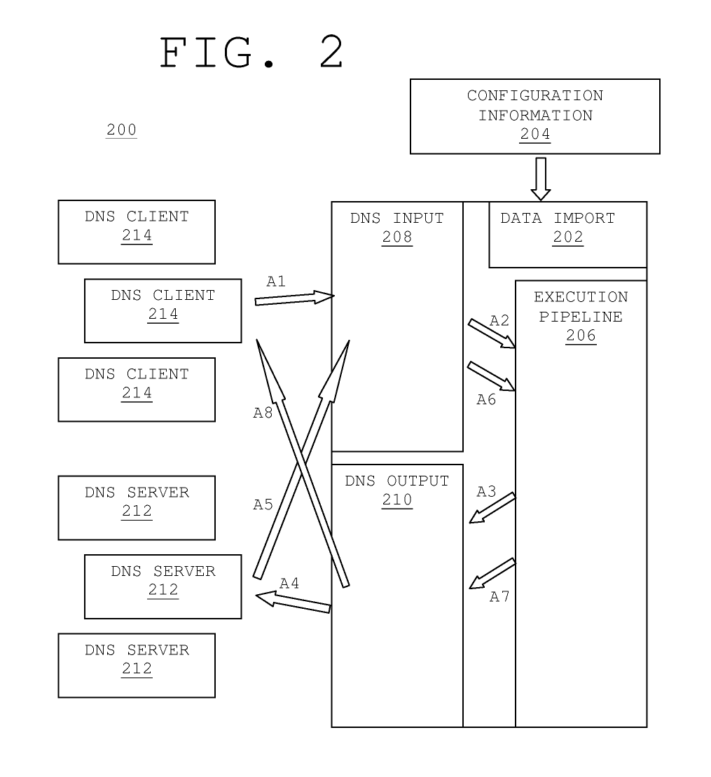

Referring to FIG. 2, an exemplary DNS switch 200 may have the following components. A data import component 202 may comprise a software or hardware module that reads data files or queries data sources, such as databases in memory, to retrieve configuration information 204 that is used to identify and determine an appropriate action for the DNS traffic. The data import component 202 may be designed to import data, for example, on a schedule, by being triggered via an external event or signal, or by being contacted by data sources themselves. Configuration information 204 may be retrieved or transmitted by TCP/IP network and stored on temporary or permanent bases in memory. In addition, an exemplary DNS switch 200 may communicate or share data among a network of other DNS switches.

The configuration information 204 may include, for example but not limited to, IP addresses of known sites associated with illegitimate traffic, patterns of clients' network traffic, and patterns of server traffic. The configuration information may comprise client, server, and DNS specifics that identify particular parts of a DNS transaction, for example but not limited to, source or destination addresses, question or answer components, rates, or other information that can be used to identify certain DNS transactions. The configuration information 204 may also include rules and/or instructions on appropriate actions based on the identified DNS transaction information. The appropriate action may be, for example, a rule that removes all DNS requests for a server known to provide illegitimate traffic or purposes, or a rule that removes a client known to be a victim to or provide illegitimate traffic. Another appropriate action may be the redirection of the client to a support server by modifying and sending a DNS response with the IP address of the support server in place of the illegitimate server. The rules/instructions may be used to serve a variety of purposes, for example but not limited to, reducing illegitimate traffic, preventing and curing infected clients, and regulating the access of the network provided to and by clients/servers.

An execution pipeline component 206 of the exemplary DNS switch 200 may comprise a hardware or software module that processes the configuration information 204 into data structures that are used to determine how a DNS transaction is processed. The execution pipeline 206 may move transactions through a number of states.

Exemplary States in the Execution Pipeline:

Query Received: A question may have been received from the client. Rules will determine whether the question should be dropped, forwarded to a DNS server, answered immediately, or a new question generated and sent to a DNS server.

Query Forward: A question may be forwarded to a DNS server for an answer. Transactions may wait in this state until an answer is received.

Answer Received: An answer may have been received from a DNS server 212. Rules may be used to determine whether the answer should be dropped, forwarded back to the client, a new answer should be generated and sent to the client, or a new question generated and sent to a DNS server 212.

Query Response: An answer may have been obtained and may be sent to the DNS client that originally sent a question.

Drop: A question or answer may be dropped/deleted.

Log: A question or answer may be recorded/archived/reported.

These states, e.g. “Query Received”, “Query Forwarded”, “Answer Received”, “Query Response”, “Drop”, and “Log”, each correspond to a table of rules generated from the configuration information. Each rule can specify client addresses, server addresses, and DNS transaction components that, when detected, dictate the next state for a transaction. In this technique, state transitions may be dictated by tables. For example, as illustrated in FIG. 2, a typical “unswitched” transaction starts in “Query Received” and transitions to “Query Forwarded,” then to “Answer Received,” and finally to “Query Response.” The flow of transactions based on the states is described in detail later herein.

A DNS input component 208 of the exemplary DNS switch 200 may be comprised of a software or hardware module that receives and parses DNS requests and responses from the network. The DNS input component 208 receives DNS UDP packets off of the network. The DNS input component may perform a validation of the packet's format, and confirms that the source of the transaction is allowed access. In the event the transaction is invalid or illegitimate, the packet may be immediately dropped. Valid transactions or transactions requiring additional processing to determine their validity may be forwarded onto the execution pipeline 206 previously discussed.

A DNS output component 210 of the exemplary system 200 may be comprised of a software or hardware module that assembles and transmits DNS requests and responses to the network. The DNS output component 210 constructs valid DNS UDP transactions and transmits them on behalf of the execution pipeline 206. The exemplary system 200 may operate as a DNS switch component. While the exemplary system 200 is disclosed as a DNS switch, the exemplary system as well as other embodiments are not limited to a switch. Embodiments may be utilized as a filter, DNS server, software or hardware on the client's computer, software associated with an application, or operating system of the client or server.

The exemplary system 200 may operate in the following manner. The data import component 202 may read files, make database queries, and/or receive configuration information 204 from the TCP/IP network. The configuration information 204 may be validated and combined into a number of tables consisting of rules. These rules state, for a particular client address, server address, or transaction component, what the actions and next state may be for a particular transaction. Once assembled, these data structures may be made available to the execution pipeline 206 by swapping in a new set of tables, under lock, for the old set.

The DNS transactions flow into the DNS input component 208 and get parsed. New transactions are typically “queries” and start in the “Query Received” state. The “Query Received” table may be consulted; any rules that match the particular client or query components are fired. These rules may dictate the action to take and possibly the next state to transition. The transaction may be dropped, responded to immediately, or forwarded to a DNS server and moved into the “Query Forwarded” state where the DNS output component 210 sends the request to a DNS Server 212.

Once the request is sent by the DNS output component 210 and the response is received, the transaction transitions into the “Answer Received” state. As with every state, the execution pipeline may consult a table of rules corresponding to the state and runs the appropriate actions. The rules in the “Answer Received” state are free to drop the transaction, forward the answer back to the originating client, generate new queries, or provide its own answer.

The flow for an “unmodified” transaction may proceed as follows. The client 214 generates a question and sends it to the DNS switch (A1). A DNS input module 212 parses the question and enters a new transaction into the execution pipeline 206 with state “Query Received” (A2). The execution pipeline 206 moves the transaction from state to state until, in this example, it reaches the “Query Forward” state where the question is ready to be sent to a DNS Server 212 (A3). A DNS output module 210 sends the question to a DNS Server 212 (A4). The DNS Server 212 responds to the request with a response (A5). The DNS input module 208 parses the answer and moves the transaction into the execution pipeline 206 with state “Answer Received” (A6). The execution pipeline 206 moves the transaction from state to state, until, in this example, it reaches the “Query Response” state where the response is ready to be sent to the DNS Client (A7). The DNS output module 210 sends the answer to the DNS Client 214 (A8).

The flow may be similar for a “modified” transaction as for an “unmodified” transaction with the execution pipeline 206 modifying the transaction. However, a “modified” transaction response may also start in “Query Received” and proceed directly to “Query Response” because a particular rule matched in the “Query Received” state caused an immediate response to be generated and sent to the client.

The invention, as described, can be structured in multiple ways. The invention can be structured as a DNS proxy where each request and response is received and transmitted by the switch, that is, each transaction is received from a client, parsed, and new transactions may be initiated with one or more DNS servers. The invention may be structured as a network packet filter where DNS UDP packets are read off the network, filtered, passed, generated, or substituted. As a network packet filter, the system may substitute its own generated packets in place of those it wished to alter. Those the system did not wish to alter may be left unmodified. In addition, the invention can be structured as a software module that plugs directly into a DNS server system. In this way, the software may perform in a similar way to the DNS proxy outlined above, however, it may pass its transactions to the real DNS server via an API or procedure call rather than via a network. In addition, the invention can be structured as a software module integrated into a library which can be linked into a client application at run-time. In this way, the actual client application would have its DNS transactions altered before they left the client's machine.

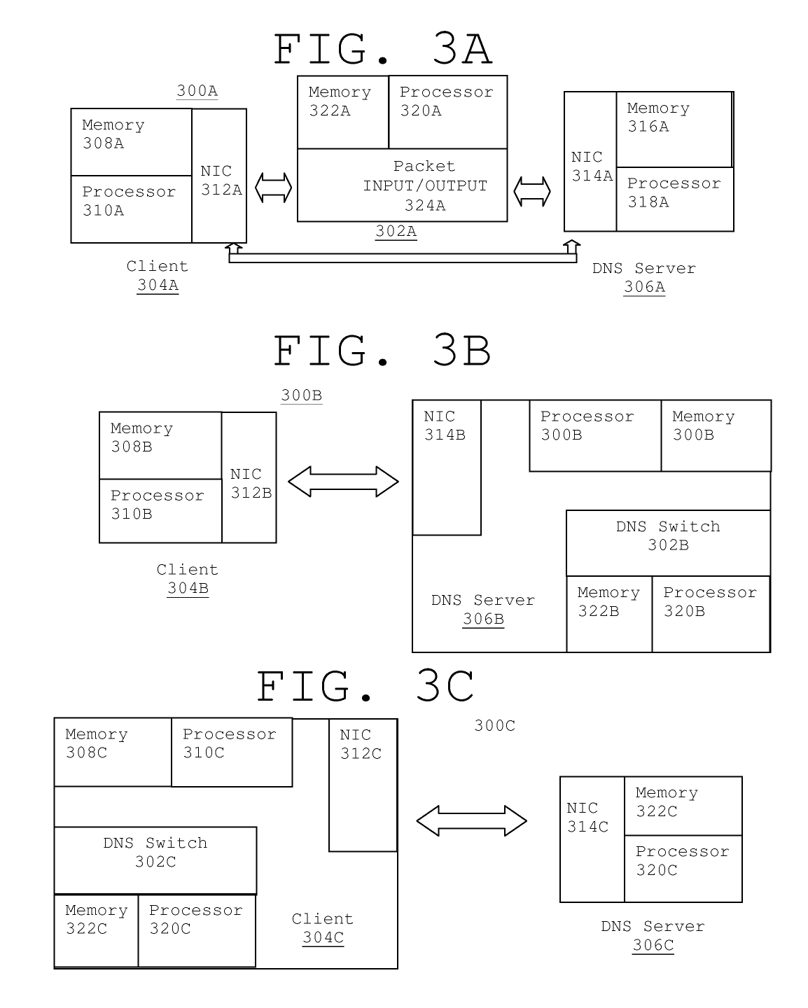

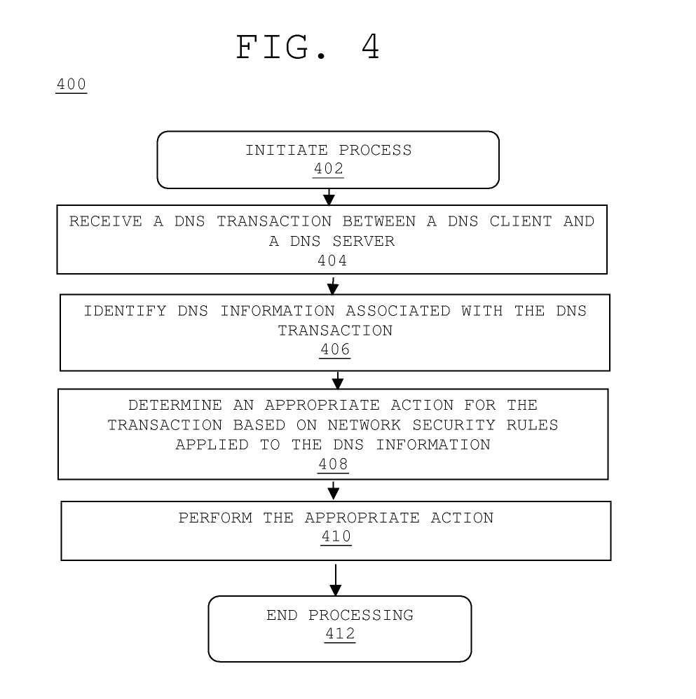

Referring to FIG. 3A, an exemplary switch embodiment 300A has an exemplary DNS switch 302A that may be positioned between a client 304A and a DNS server 306A. As DNS transactions are conducted between the client 304A and the DNS server 306A, requests and responses sent to and from the DNS server 306A may be received by the DNS switch 302A, as previously described. An application operating from the memory 308A and processor 310A of the client 304A may send a request for identifying information associated with a website via a network card 312A over the network. The DNS server 306A receives the request via a server network card 314A and processes the requests using memory 316A and processor 318A of the DNS server 306A. The processing may involve reconciling with other DNS servers as previously described. Once the resource record is identified by the website, a response is transmitted by the DNS server 306A back to the client 304A. An appropriate action of the DNS switch 302A may be determined using a processor 320A and memory 322A of the DNS switch 302A as previously discussed with regard to FIG. 2. A packet input/output 324A may be used to communicate with the client 304A and server 306A.

The DNS switch 302A may respond directly to requests sent from the client 304A bound for the DNS server 306A. For example, the DNS switch 302A may drop the request, thus leaving the request of the client 304A unanswered and reducing network traffic. In another example, the DNS switch 302A may transmit a response with an IP address different from the IP address requested by the client 304A in order to prevent the client 304A or the client's machine from conducting illegitimate network communications. In this example, the transaction may never reach the DNS server 306A.

In another example, the DNS switch 302A may receive the request and process a transaction with the DNS server 306A to provide a response from the DNS switch 302A to the client 304A. The DNS switch 302A may also receive responses bound for the client 304A from the DNS server 306A. The DNS switch 302A may modify the response being transmitted to the client 304A based on the response of the DNS server 306A. The DNS switch 302A may be positioned at a variety of locations between the client 304A and the DNS server 306A. For example, the DNS switch may be a device located at the ISP or other network service provider, a device located within a local network of the client 304A, or a device located on a DNS server 306A.

Referring to FIG. 3B, an exemplary switch embodiment 300B has an exemplary DNS switch 302B that may be implemented within a DNS server 306B. The DNS switching may be put into practice as a part of the processing of the DNS transactions by the DNS server 306B. A request is sent from a DNS client 302B by an application operating from the memory 308B and processor 310B of the client 304B for identifying information associated with a website via a network card 312B over the network. The DNS server 306B receives the request via a server network card 314B and processes the request using memory 316B and processor 318B of the DNS server 306B. An appropriate action of the DNS switch 302B may be determined using a processor 320B and memory 322B of the DNS switch 302A or the DNS server 306B may use the same processor and memory to perform both operations of identifying the resource record and regulating the network traffic.

Referring to FIG. 3C, an exemplary switch embodiment 300C has an exemplary DNS switch 302C that may be implemented within a client 302C. The DNS switching 304C may be put into practice as a part of the transmitting and receiving of the DNS transactions by the client 302C. A request may be sent from a client 302C by an application operating from the memory 308C and processor 310C of the client 304C. An appropriate action of the DNS switch 302C may be determined using a processor 320C and memory 322C of the DNS switch 302C or the client 304C may use the same processor and memory to perform both operation of the application and regulation of the network traffic. The DNS request may be modified or dropped before ever leaving the client's machine. In this exemplary embodiment, the DNS server 306C receives the request via a server network card 314C and processes the requests using memory 316C and processor 318C of the DNS server 306C. The DNS switching 302C may be accomplished by the application or another application operating within the client 304C. For example, the DNS switching 302C may be performed by a browser application or computer security application. In one example, the DNS switching may be a part of the DNS caching performed by the browser application.

Although the examples herein may use network transactions associated with IP addresses for websites, embodiments are not limited to these transactions and may be used for a variety of network transactions. Embodiments of the invention may be used for monitoring or regulating any DNS transaction that may be processed by a DNS server. In addition, embodiments can be used, but are not limited to, rate-limiting or throttling DNS transaction rates, serving as a DNS firewall or filter, serving as a DNS router, or acting as a DNS transaction monitor or logger. As previously disclosed, embodiments may be implemented by utilizing a device positioned between the DNS client 214 and the DNS server 212. The embodiments may provide a convenient way to affect any part of a provider's DNS service without requiring a major server reconfiguration. Embodiments may offer a provider the ability to alter DNS transactions on their network rapidly. Since changing the set of DNS transactions involves loading a small number of rules, the provider gains the ability to alter their DNS infrastructure quickly and easily.

Another benefit that may be provided is the ability to enable the use of DNS switching as a “soft” method of quarantining client machines. If a provider wishes to quarantine a customer or collection of customers for an arbitrary reason, e.g. malware infection, delinquent bill, etc., the provider can use embodiments to respond to all of their DNS queries with a specific set of DNS answers. This may allow the ability for the customer to still be “online” and not have their service fully terminated. The customer can optionally be allowed to reach self-help destinations where they can remediate the reason they were quarantined, and furthermore the customer can be rapidly re-enabled to full service with a simple configuration update and minimal support.

Referring to FIG. 4, a flowchart of an exemplary method used for the switching method is provided. The client 214 initiates the DNS transaction (block 402). The DNS switch receives either the DNS request of the client 214 or the response from the DNS server 212 (block 404). The DNS switch parses the request or response to identify information associated with the DNS transaction (block 406). This information may be a variety of data as previously discussed. The DNS switch applies network security rules to the information and determines the appropriate action for the DNS transaction (block 408). The network security rules, as previously discussed, may be a variety of network regulation. Based on the rules, an appropriate action may be taken with regard to the DNS transaction or future DNS transaction as will be discussed later herein. For example, DNS transactions associated with malware detection may result in dropping or quarantining of a client, which may cause DNS transactions to be dropped or modified with the quarantined IP address.

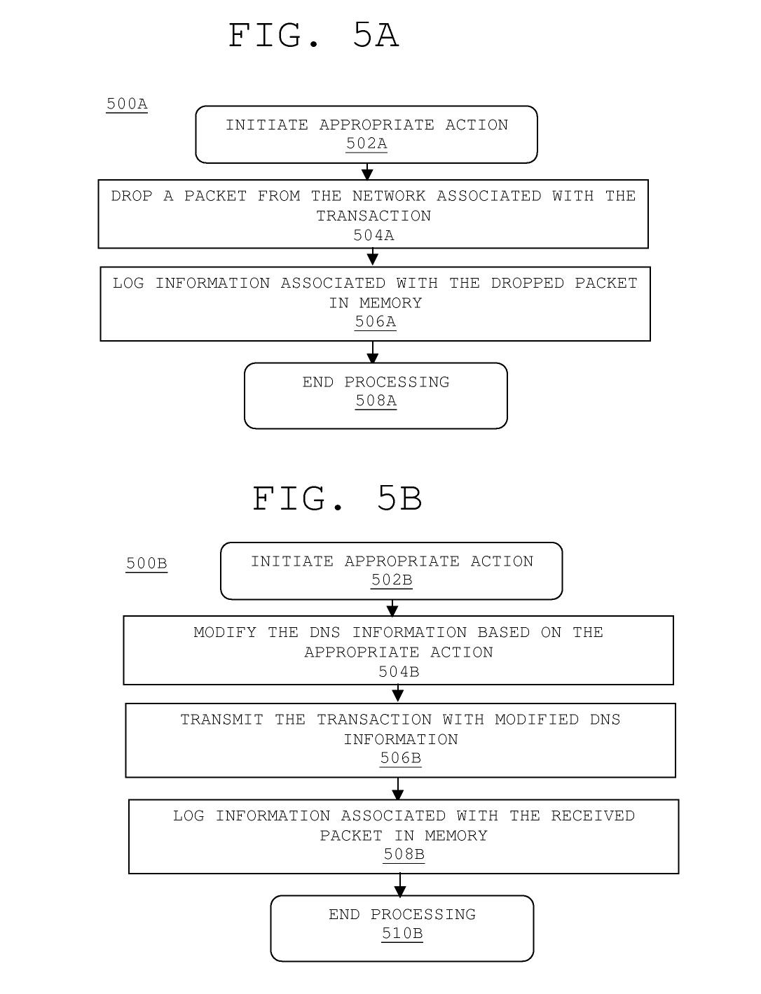

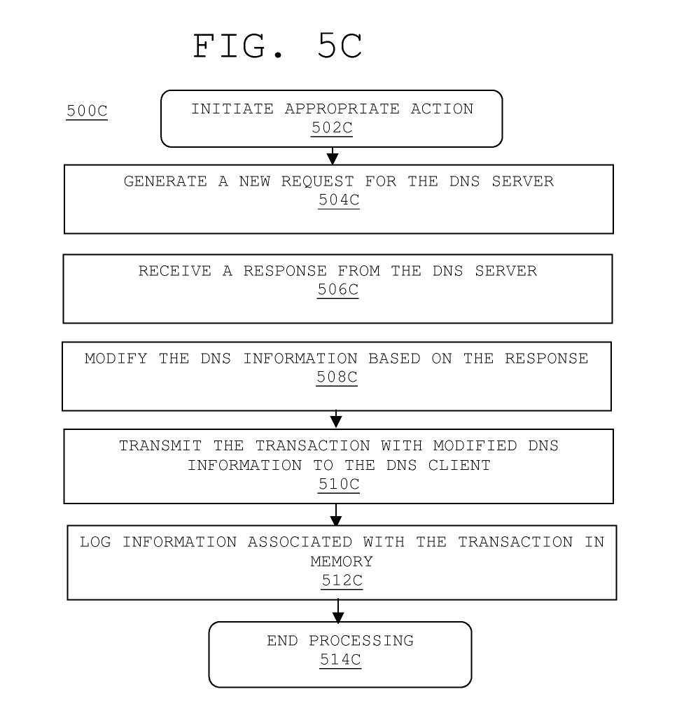

Referring to FIG. 5A, a flowchart of an exemplary switching method causing the transaction to be dropped is provided. The DNS switch determines and initiates the appropriate action for the DNS transaction (block 502A). For example, if the DNS transaction is associated with malware, the DNS switch may drop the packet from the network (block 504A). The DNS switch may also log the event for future or present actions (block 506A). For example, a logged event may trigger a rule after a specified number of certain DNS transactions. The process is completed and the DNS switch waits for the next DNS transaction (block 508A).

Referring to FIG. 5B, a flowchart of an exemplary switching method causing the transaction to be modified is provided. The DNS switch determines and initiates the appropriate action for the DNS transaction (block 502B). For example, if the DNS transaction is associated with malware, the DNS switch may modify the requested IP address to an IP address associated with a support server providing an application the client may use to remove the malware from the client's machine (block 504B). The DNS switch may identify the malware by the request of the client 214 or the response of the DNS server 212. The DNS switch may either modify the response of the DNS server 212 or send a response based on the client's DNS request. The modified DNS request is transmitted to the client (block 506B). The DNS response may cause the client's machine to access the support server and direct the client to a website for support on removing the malware. The DNS switch may also log the event for future or present actions (block 508B). The process is completed and the DNS switch waits for the next DNS transaction (block 510B).

Referring to FIG. 5C, a flowchart of an exemplary switching method for causing the transaction to be identified and modified is provided. The DNS switch determines and initiates the appropriate action for the DNS transaction (block 502C). The DNS switch may generate and transmit a request to the DNS server 212 based on the request received (block 504C). The response from the DNS server associated with the DNS request of the switch is received (block 506C). For example, the client may be restricted from accessing pornography; the DNS request may not be associated with a known pornography website but the DNS response may be known to be associated with pornography. Accordingly, the DNS switch may modify the response IP address (block 508C). The response is transmitted to the client that, based on the modified DNS response, will access an IP address associated with a support server providing a warning or restricting access of the client's machine (block 510C). The DNS switch may also log the event for future or present actions (block 512C). The process is completed and the DNS switch waits for the next DNS transaction (block 514C).

Modifications and substitutions by one of ordinary skill in the art are considered to be within the scope of the present invention, which is not to be limited except by the following claims.

The invention claimed is:

1. A method for regulating networks using Domain Name System (DNS) comprising the acts of:
receiving a DNS transaction between a DNS client and a DNS server;
identifying DNS information associated with the DNS transaction; and
determining an appropriate action for the transaction based on network security rules applied to the DNS information.

2. The method of claim 1, wherein the appropriate action drops the transaction and the method further comprises:
dropping a packet from the network associated with the transaction.

3. The method of claim 1, wherein the appropriate action modifies the DNS information and the method further comprises:
modifying the DNS information based on the appropriate action; and
transmitting the transaction with modified DNS information.

4. The method of claim 1, wherein the appropriate action modifies the DNS information and the method further comprises:
generating a new request for the DNS Server;
receiving a response from the DNS Server;
modifying the DNS information based on the response; and
transmitting a response with modified DNS information to the DNS client.

5. The method of claim 1, wherein the DNS switch resides within a DNS server.

6. The method of claim 1, wherein the DNS switch resides within a computer of a DNS client.

7. The method of claim 1, wherein the DNS switch resides between a DNS server and a DNS client.

8. The method of claim 1, wherein the DNS switch resides within a DNS server of an Internet Service Provider (ISP).

9. The method of claim 1, wherein the transaction is a request sent from the DNS client to the DNS server.

10. The method of claim 1, wherein the transaction is a response sent from the DNS server to the DNS client.

11. The method of claim 1, further comprising:
modifying the network security rules applied to the DNS information based on network traffic.

12. A Domain Name System (DNS) switch for maintaining a network comprising:
DNS input for receiving DNS requests and responses;
memory for storing network rules relating to handling DNS requests and responses;
processor for identifying DNS information associated with the DNS requests and responses, applying the network rules to the DNS information, and producing a DNS switch response based on the applied network rules; and
DNS output for transmitting the DNS switch responses.

13. The DNS switch of claim 12 wherein the DNS switch resides within a DNS server.

14. The DNS switch of claim 12, wherein the DNS switch resides within a computer of a DNS client.

15. The DNS switch of claim 12, wherein the DNS switch resides between a DNS server and a DNS client.

16. The DNS switch of claim 12, wherein the DNS switch resides within a DNS server of an Internet Service Provider (ISP).

17. The DNS switch of claim 12, wherein the processor applying network rules determines legitimate DNS requests of a DNS client and produces a DNS switch response to respond to the DNS Client request via the DNS output; transmits the DNS switch response and determines illegitimate DNS requests of a DNS client and produces no DNS switch response to respond to the DNS Client request.

18. The DNS switch of claim 12, wherein the processor applying network rules determines illegitimate DNS requests of a DNS client and produces a DNS switch request and via the DNS output transmits the DNS switch request to a DNS server; and
the DNS server produces a response to the DNS switch request that is sent to the DNS client.

19. The DNS switch of claim 12, further comprising
a network server with memory and a processor for monitoring network traffic and modifying the network rules in the DNS switch memory based on network traffic patterns.

20. The DNS switch of claim 19, wherein the network traffic patterns are patterns of DNS requests for IP addresses on the network.

21. A method for identifying and quarantining a client on a network using Domain Name System (DNS) comprising the acts of:
receiving a DNS request from the client;
identifying DNS information associated with the DNS request;
determining that the DNS request is associated with one of a zombie, a bot, a virus and a worm located on the client; and
dropping a packet with the DNS request of the client from the network.

22. The method of claim 21, further comprising the acts of:
modifying the DNS information to an Internet Protocol (IP) address of a quarantine site; and
transmitting a response with modified DNS information to the client.

23. The method of claim 22, further comprising the acts of:
receiving additional DNS requests from the client;
identifying DNS information associated with the additional DNS request;
modifying the DNS information to an Internet Protocol (IP) address of a quarantine site for the additional requests; and
transmitting additional responses with modified DNS information to the client.

24. The method of claim 21, further comprising the acts of:
modifying the DNS information to an Internet Protocol (IP) address of a support site with instructions to remove the one of a zombie, a bot, a virus and a worm located on the client; and
transmitting a response with modified DNS information to the client.

25. The method of claim 21, further comprising the acts of:
receiving the DNS response from a DNS Server associated with the DNS request from the client; and
dropping a packet with the DNS response for the client from the network.

26. The method of claim 21, further comprising:
modifying network filtering rules used to determine if the DNS request is associated with one of a zombie, a bot, a virus and a worm located on the client based on network traffic patterns.

27. The method of claim 21, further comprising:
modifying network filtering rules used to determine if the DNS request is associated with one of a zombie, a bot, a virus and a worm located on the client based on patterns of DNS requests of the client.

28. The method of claim 21, wherein a DNS filter applying the method for identifying and quarantining a client on a network using DNS resides within a DNS server.

29. The method of claim 21, wherein a DNS filter applying the method for identifying and quarantining a client on a network using DNS resides within a computer of a DNS client.

30. The method of claim 21, wherein a DNS filter applying the method for identifying and quarantining a client on a network using DNS resides between a DNS server and a DNS client.

31. A method for regulating a client's activity on a network using Domain Name System (DNS) comprising the acts of:
receiving a DNS request from the client;
identifying DNS information associated with the DNS request;
determining that the DNS request is associated with a regulated site of the client; and
dropping a packet with the DNS request of the client from the network.

32. The method of claim 31, further comprising the acts of:
modifying the DNS information to an Internet Protocol (IP) address of an alert site warning the client of the attempt to access a regulated site; and
transmitting a response with modified DNS information to the client.

33. The method of claim 31, further comprising:
generating a new request for a DNS Server;
receiving a response from the DNS Server;
determining that the DNS response is associated with a regulated site of the client; and
dropping a packet associated with the DNS response from the network.

34. The method of claim 31, further comprising:
generating a new request for a DNS Server;
receiving a response from the DNS Server;
determining that the DNS response is associated with a regulated site of the client;
modifying the DNS information of the response; and
transmitting a response to the client with the modified DNS information to the DNS client.

35. The method of claim 31, wherein a client-regulating module applying the method resides within a DNS server.

36. The method of claim 31, wherein a client-regulating module applying the method resides within a computer of a DNS client.

37. The method of claim 31, wherein a client-regulating module applying the method resides between a DNS server and a DNS client.
